(19) United States
(12) Patent Application Publication
(10) Pub. No.: US 2009/0186501 A1
(43) Pub. Date: Jul. 23, 2009

(54) Clamping Device

(75) Inventor: Ming-Hui Kao, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/149,110

(22) Filed: Apr. 28, 2008

(30) Foreign Application Priority Data
Jan. 18, 2008 (TW) 097201206

(51) Int. Cl. H01R 13/62

(52) U.S. Cl. 439/153

(57) ABSTRACT

A clamping device for connecting to an interface card socket with a slot and an electrical connection portion. The clamping device comprises a main body and a cover portion, wherein the cover portion is connected to the main body and the cover portion includes an airtight element for covering the slot.

### BACKGROUND OF THE INVENTION

1. Field of the Invention

The present invention relates to a clamping device. It is more particularly to a clamping device capable of preventing various substances from entering an interface card socket.

2. Description of the Related Art

Interface cards (such as a DIMM card, or Dual Inline Memory Module) are of great importance in the IT industry, as nearly all IT products comprise interface cards. However, during fabrication and testing of a system, it is often found that the interface card cannot be read, with the result that the system cannot operate normally. The main cause of this malfunction is the spraying of the mainboard with a soldering flux during production to ensure that all electronic elements can be welded on the mainboard tightly, without clod welding or false welding. When the soldering flux is sprayed, the soldering flux, which is in a gaseous state is dissipated throughout the air surrounding the main board, and a portion of the soldering flux will inevitably enter the interface card socket. If the soldering flux which goes into the interface card socket covers any electric contacts in the socket, the resulting blocked contact cannot connect with the interface card, and the interface card socket is thus rendered defective.

In the prior art, there is a manual procedure for sealing the slot of the interface card socket with tape in advance of spraying the soldering flux. However, the tape cannot be reused, and the procedure of pasting and removing the tape relies entirely on manpower. The step of removing the tape in particular requires proficiency, with a resultant demand on skilled manpower.

Therefore, it is desirable to provide a reusable clamping device capable of preventing various substances from entering an interface card socket to mitigate and/or obviate the aforementioned problems.

### SUMMARY OF THE INVENTION

An objective of the present invention is to provide a clamping device capable of preventing a substance from entering an interface card socket.

In order to achieve the objective, a clamping device of the invention comprises a main body and a cover portion, wherein the cover portion is connected to the main body, and the cover portion comprises an airtight element for covering the slot.

According to one embodiment of the invention, the cover portion comprises at least one rib. When the cover portion covers the slot, the airtight element is pressed between the rib and the slot.

According to another embodiment of the invention, the cover portion comprises a contact portion. When the cover portion covers the slot, the contact portion comes into contact with the electrical connection portion of the interface card socket.

Other objects, advantages, and novel features of the invention will become more apparent from the following detailed description when taken in conjunction with the accompanying drawings.

### BRIEF DESCRIPTION OF THE DRAWINGS

FIG. 1 is an exploded drawing of the first embodiment of a clamping device of the invention.

FIG. 2 is a perspective drawing of the first embodiment of a clamping device of the invention.

FIG. 3 is the top view of a prior art interface card socket.

FIG. 4 is an exploded drawing of a clamping device of the invention and an interface card socket.

FIG. 5 is a perspective drawing of a clamping device of the invention installed in the interface card socket.

FIG. 6 is a schematic drawing of the second embodiment of the clamping device.

### DETAILED DESCRIPTION OF THE PREFERRED EMBODIMENT

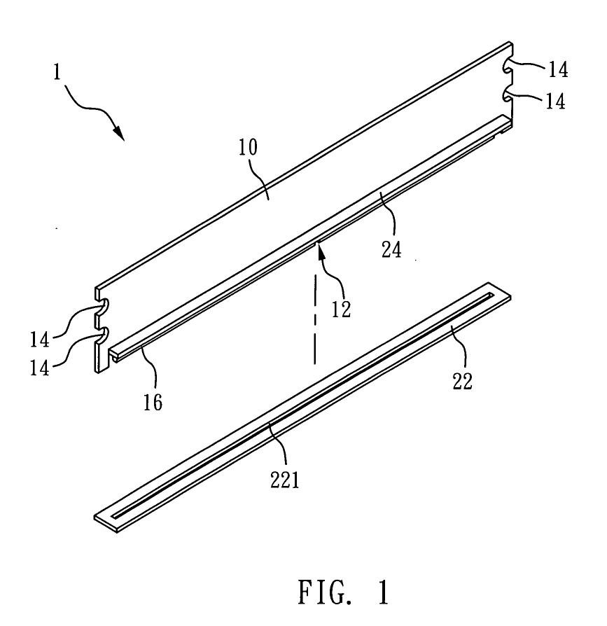

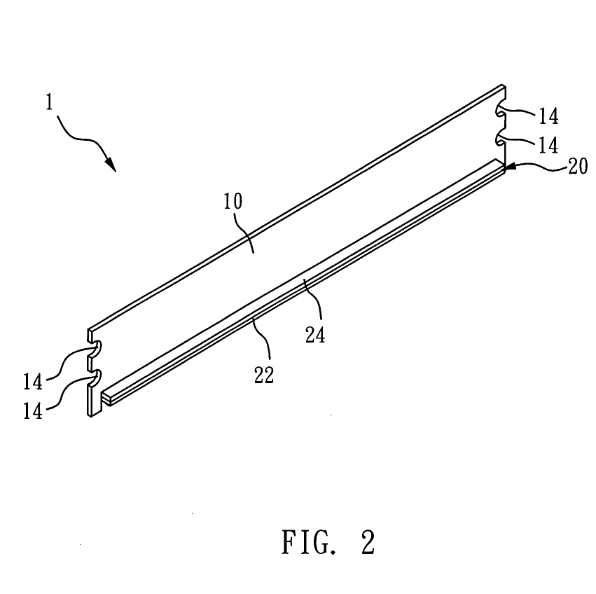

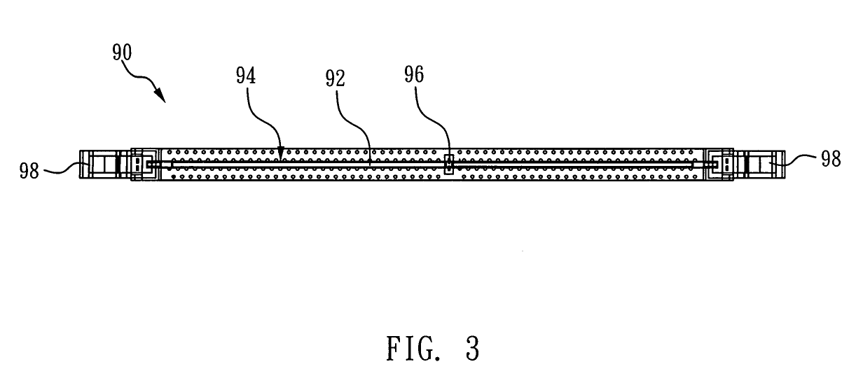

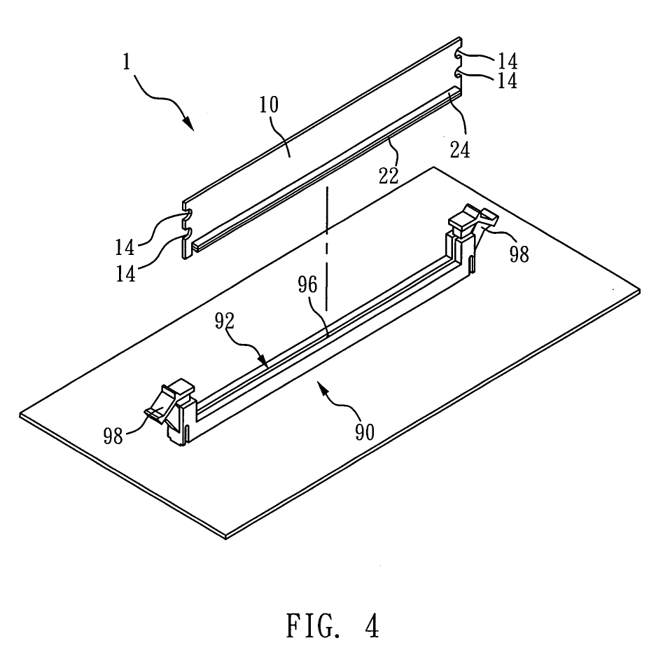

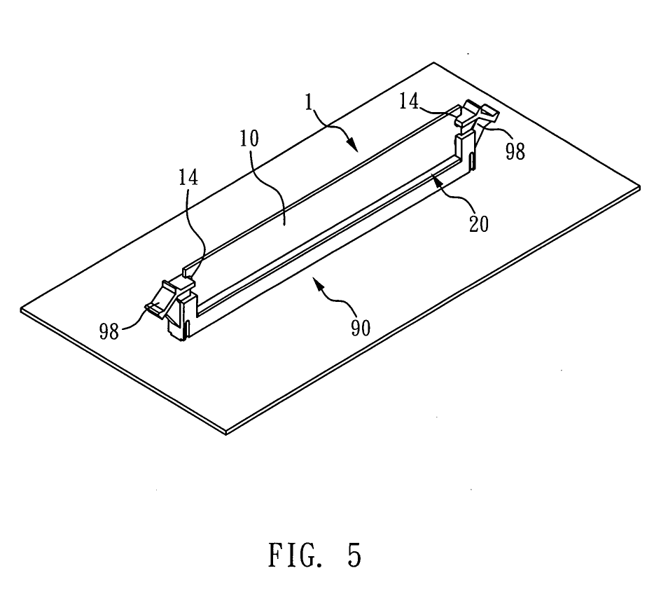

Please refer to FIG. 1 to FIG. 5. FIG. 1 is an exploded drawing of the first embodiment of a clamping device. FIG. 2 is a perspective drawing of the first embodiment of a clamping device. FIG. 3 is the top view of a prior art interface card socket. FIG. 4 is an exploded drawing of a clamping device and an interface card socket. FIG. 5 is a perspective drawing of a clamping device installed in the interface card socket.

The clamping device 1 of the invention is used for connecting to the prior art interface card socket 90 (as shown in FIG. 3 and FIG. 4). The interface card socket 90 comprises a slot 92, an electrical connection portion 94, a protrudent portion 96, and a fastener 98. It should be noted that the combination of the interface card socket 90 is not limited to the above description.

In this embodiment, the interface card socket 90 is a DIMM (Dual Inline Memory Module) card socket. It needs to be noted that the interface card socket 90 can also be other types of sockets. At this time, the only aspect of the clamping device 1 that needs to be changed is the size. For example, when the number of the electric contacts of the electrical connection portion 94 of the interface card socket 90 is 184 pins, the clamping device is longer than the number of the electric contacts is 168 pins. In summary, the length of the clamping device may vary according to the number of electric contacts.

The clamping device 1 comprises a main body 10 and cover portion 20. The fastener 98 of the interface card socket 90 can connect to the main body 10, so the clamping device 1 is firmly connected to the interface card socket 90.

In this embodiment, the main body 10 comprises an indentation portion 12 and a fixing portion 14. The main body is designed based upon an actual interface card, so the bottom of it can directly insert into the interface card socket 90. The main body 10 is made of plastic, and the length of the main body 10 is substantially equal to the length of the slot 92. It should be noted that the shape, size, and material of the main body is not limited in the above description.

The fixing portion 14 is buckled by the fastener 98 of the interface card socket 90. In this embodiment, the fixing portion 14 is an opening in a semicircular shape for being buckled by the fastener 98 which matches the fixing portion 14 to achieve the fixing effect. In this embodiment, in order to suit different types (different heights, for example) of the interface card socket 90, each of the two opposite sides of the main body 10 comprises two fixing portions 14.

It needs to be noted that the number of the fixing portions 14 is not limited in the above description. In addition, in addition to the buckling fashion, the fastener 98 can also fix the fixing portions 14 in other fashions.

It also needs to be noted that when the interface card socket 90 does not have the fastener 98, or the interface card socket 90 has a structure matching the shape of the main body 10 (the fastener 98 has a slot, for example), the main body 10 cannot comprise the fixing portion 14.

In order to improve the fixing effect, the shape of the indentation portion 12 (as shown in FIG. 1) of the main body 10 and the protrudent portion 96 (as shown in FIG. 4) protruded from the slot 92 are matched with each other, and the indentation portion 12 and the protrudent portion 96 are in the relation of a tight fit. The main body 10 can be fixed inside the interface card socket 90 by the indentation portion 12 wedging the protrudent portion 96. When the main body 10 is fastened inside the interface card socket 90, the protruding portion 96 is fixedly connected to the indentation portion 12.

In this embodiment, the protrudent portion 96 is in the middle position of the slot 92. It should be noted that the shape, position, and number of the indentation portion 12 are not limited in the above description. In addition, if the fixing and connecting effect is already achieved by any other structure of the clamping device 1, the main body 10 cannot comprise the indentation portion 12.

The cover portion 20 is connected to the main body 10. When the cover portion 20 covers the slot 92 (as shown in FIG. 5), it prevents various substances (for example, soldering flux in a gaseous state) from entering the interior of the interface card socket 90 during the manufacturing of the main board.

In this embodiment, the cover portion 20 comprises an airtight element 22 and a rib 24. The airtight element 22 covers the slot 92 directly, so the slot 92 and the airtight element 22 are substantially in the relation of a tight fit. The airtight element 22 is made of soft silica gel. Due to the material characteristics of the silica gel, the airtight element 22 can press the slot 92 tightly to ensure the tight fit. It needs to be noted that the material of the airtight element 22 is not limited in the above description.

When the cover portion 20 covers the slot 92, the airtight element 22 is pressed between the rib 24 and the slot 92. The rib 24 has the function of enhancing the airtight effect of the airtight element 22. In further description, when the cover portion 20 covers the slot 92, the rib 24 provides the force applied on the airtight element 22, thus improving the airtight effect.

In order to connect the airtight element 22 to the main body 10 easily, in this embodiment, the airtight element 22 comprises an interstice 221. By the connection unit 16 of the main body 10 inserting into the interstice 221, the airtight element 22 connects to the main body 10. It needs to be noted that the way of the airtight element 22 connecting to the main body 10 is not limited in the above description. For instance, the airtight element 22 can be pasted on the rib 24 with an adhesive.

It should be noted that the composition of the cover portion 20 is not limited in the above description. For example, the cover portion 20 may only comprise the rib 24. At this time, the rib 24 covers the slot 92 of the interface card socket 90 directly. Alternatively, the cover portion 20 may only comprise the airtight element 22.

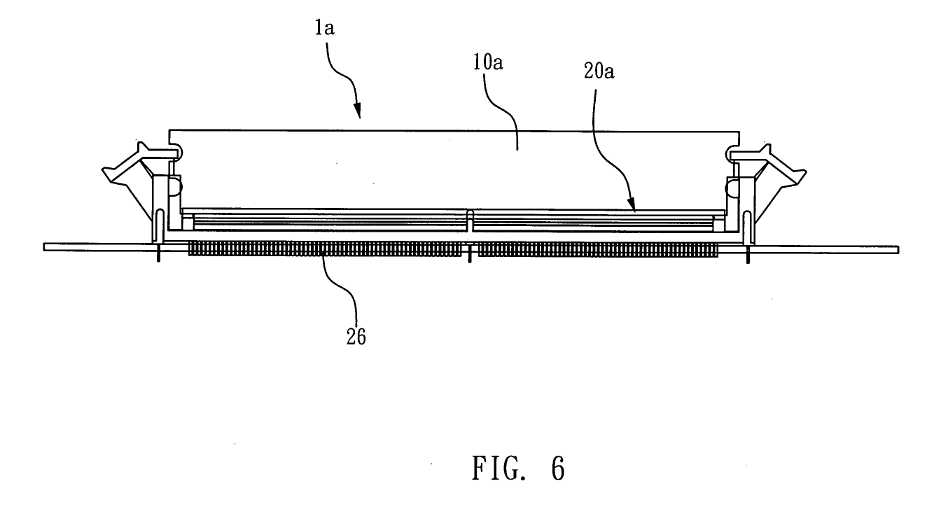

Please refer to FIG. 6. FIG. 6 is a schematic drawing of the second embodiment of the clamping device. The clamping device 1a comprises a main body 10a and a cover portion 20. The main difference from the first embodiment in the above description is that the cover portion 20a comprises a contact portion 26. The contact portion 26 can make contact with the electrical connection portion 94 of the interface card socket 90. The contact portion 26 has the further effect of preventing various substances from entering the interior of the interface card socket 90.

When the cover portion 20 covers the slot 92, the contact portion 26 covers the electrical connection portion 94 simultaneously. Should even a minor amount of any substance pass the airtight element 22 and enter the interface card socket 90, the contact portion 26, which is in direct physical contact with the electrical connection portion 94, will prevent the substance from touching the electrical connection portion 94. Therefore, the double protection of the airtight element 22 and the contact portion 26 ensures that various substances cannot block the electrical contacts in the interface card socket 90.

The following illustrates the practical use of the clamping device 1 of the present invention. Please refer to FIG. 4. A user inserts the clamping device 1 into the interface card socket 90, as with an ordinary interface card. Then the user manipulates the fasteners 98 at the two ends of the interface card socket 90 to ensure that the fasteners 98 fix the fixing portion 14. After fixing, the assembly is in the state as shown in FIG. 5. At this time, the main board can proceed to the following process. Due to the block provided by the clamping device 1, the chance of various substances entering the interface card socket 90 is minimized.

Although the present invention has been explained in relation to its preferred embodiment, it is to be understood that many other possible modifications and variations can be made without departing from the spirit and scope of the invention as hereinafter claimed.

1. A clamping device for connecting to an interface card socket, the interface card socket comprising a slot and an electrical connection portion, the clamping device comprising:
a main body; and
a cover portion connected to the main body and having an airtight element for covering the slot.

2. The clamping device as claimed in claim 1, wherein the airtight element comprises an interstice for connecting to the main body.

3. The clamping device as claimed in claim 1, wherein the cover portion further comprises at least one rib, and when the cover portion covers the slot the airtight element is pressed between the rib and the slot.

4. The clamping device as claimed in claim 1, wherein the cover portion comprises a contact portion, and when the cover portion covers the slot the contact portion comes into contact with the electrical connection portion.

5. The clamping device as claimed in claim 4, wherein the cover portion further comprises at least one rib, and when the cover portion covers the slot the airtight element is pressed between the rib and the slot

6. The clamping device as claimed in claim 5, wherein the interface card socket further comprises at least one protrudent portion protruded from the slot, the main body further comprises an indentation portion, and when the main body is fastened inside the interface card socket the protruding portion is fixedly connected to the indentation portion.

7. The clamping device as claimed in claim 1, wherein the interface card socket further comprises at least one protrudent portion protruded from the slot, the main body further comprises an indentation portion, and when the main body is fastened inside the interface card socket the protruding portion is fixedly connected to the indentation portion.

8. The clamping device as claimed in claim 1, wherein the airtight element is made of silica gel.

9. A clamping device for connecting to an interface card socket, the interface card socket comprising a slot, an electrical connection portion, and a fastener; the clamping device comprising:
a main body fixed by the fastener; and
a cover portion connected to the main body for covering the slot.

10. The clamping device as claimed in claim 9, wherein the cover portion comprises an airtight element for covering the slot,

11. The clamping device as claimed in claim 10, wherein the airtight element is made of silica gel.

12. The clamping device as claimed in claim 10, wherein the airtight element comprises an interstice for connecting to the main body.

13. The clamping device as claimed in claim 9, wherein the main body further comprises at least one fixing portion, the fastener being buckled to the fixing portion.

14. The clamping device as claimed in claim 9, wherein the main body includes a first fixing portion and a second fixing portion, the first and second fixing portions being respectively disposed at two edge portions of the main body.

15. The clamping device as claimed in claim 9, wherein the cover portion comprises at least one rib.

16. The clamping device as claimed in claim 10, wherein the cover portion further comprises at least one rib, and when the cover portion covers the slot the airtight element is pressed between the rib and the slot.

17. The clamping device as claimed in claim 9, wherein the cover portion comprises a contact portion, and when the cover portion covers the slot, the contact portion comes into contact with the electrical connection portion.

18. The clamping device as claimed in claim 9, wherein the interface card socket further comprises at least one protrudent portion protruded from the slot, the main body further comprises an indentation portion, and when the main body is fastened inside the interface card socket the protruding portion is fixedly connected to the indentation portion.

19. The clamping device as claimed in claim 1, wherein the main body is not electrically connected to the electrical connection portion.

20. The clamping device as claimed in claim 9, wherein the main body is connected to the electrical connection portion in a non-electrical manner.
